(19) United States
(12) Patent Application Publication
(10) Pub. No.: US 2026/0300105 A1
(43) Pub. Date: Oct. 1, 2026

(54) DATA BACKUP SYSTEM

(71) Applicant: TF-Industries GmbH, Bochum (DE)

(72) Inventor: Fabian GIESHOFF, Neuenrade (DE)

(21) Appl. No.: 19/479,293

(22) PCT Filed: Apr. 26, 2024
(86) PCT No.: PCT/EP2024/061635

§ 371 Date: Oct. 27, 2025

(30) Foreign Application Priority Data
Apr. 27, 2023 (DE) 10 2023 110 885.9

(51) Int. Cl. G06F 11/1446

(52) U.S. Cl. CPC G06F 11/1464; G06F 2201/805

(57) ABSTRACT

The invention relates to a data backup system (1, 101) for data to be backed up from a data network (31), wherein the data backup system (1, 101) comprises a backup memory (33), wherein the data backup system (1, 101) further comprising a first bridge (21), an intermediate storage (32) and a second bridge (22), wherein the data backup system (1, 101) and/or the first bridge (21) comprise a data backup system interface (221) for a first data transmission connection (41) for directly or indirectly connecting the data network (31) and the first bridge (21) for data communication, wherein the first bridge (21) and the intermediate storage (32) are connected for data communication by means of a second data transmission connection (42), wherein the intermediate storage (32) and the second bridge (22) are connected for data communication by means of a third data transmission connection (43), wherein the second bridge (22) and the backup storage (33) are connected for data communication by means of a fourth data transmission connection (44), wherein the data backup system (1, 101) comprises a controller (2, 102) configured in such a way as to interrupt a power supply for the first bridge (21) and to interrupt the power supply for the second bridge (22) so that at least the power supply for the first bridge (21) or the power supply for the second bridge (22) is interrupted.

The invention relates to a data backup system. The invention also relates to a network system with a data backup system. The invention also relates to a method for operating a network system.

A data backup system is disclosed, for example, in the article Shon et al., ‘A robust and secure backup system for protecting malware’, dl.acm.org/doi/abs/10.1145/3297280.3297424.

EP 2 953 150 B1 discloses a device for limiting or interrupting the current in an electrical circuit and a control method therefor. The device comprises a current interruption branch and a bridge branch. The bridge branch comprises two bridge arms formed by four identical current commutation branches. Two of the four current commutation branches are connected in series, and the two bridge arms formed are then connected in parallel. The two bridge arms are both connected in parallel to the current interruption branch, and the midpoints of the two bridge arms are connected separately to two points of the circuit. Each current commutation branch comprises at least one high-speed interrupt switch and at least one bidirectional power semiconductor switch, both of which are connected in series with each other. The device can switch off a bidirectional current.

DE 196 47 655 A1 discloses a backup device that allows a primary server to be removed from the network and a secondary server to be connected, regardless of the type of malfunction occurring in a network. This is achieved by providing means for interrupting the power supply to the primary server.

DE 10 2008 029 902 A1 discloses a method for operating a bus system comprising a first and at least one second network node (MASTER, SLAVE). A first and a second line (BUS, GND) are provided for supplying power to the at least one second network node (SLAVE) and for communication between the first and the at least one second network node (MASTER, SLAVE). Communication between the first and at least one second network node (MASTER, SLAVE) and the power supply to the at least one second network node (SLAVE) are each carried out via the first line (BUS) and are separated from each other in time.

The object of the invention is to specify a data backup system that is particularly well protected against manipulation or to improve data backup in a network system. It is desirable to achieve ease of use and minimisation of risk in relation to external attacks during data backup and/or data recovery.

The aforementioned object is solved by a data backup system for a data network (base network, also known as LAN (e.g. company network)), wherein the data backup system comprises a back-up storage (in particular for storing data from the data network), wherein the data backup system further comprises a first bridge (comprising a lock or sluice), an intermediate storage and a second bridge, wherein the data backup system and/or the first bridge comprises a data backup system interface for a first data transmission connection for the direct or indirect data communication of the data network and the first bridge, wherein the first bridge and the intermediate storage device are connected for data communication by means of a second data transmission connection, wherein the intermediate storage and the second bridge are connected for data communication by means of a third data transmission connection, wherein the second bridge and the back-up memory are connected for data communication by means of a fourth data transmission connection, wherein the data backup system comprises a controller configured to interrupt a power supply for the first bridge and to interrupt a/the power supply for the second bridge, so that (in intended operation) at least the power supply for the first bridge or the power supply for the second bridge is interrupted.

A bridge within the meaning of this disclosure may be a Switch. A bridge within the meaning of this disclosure may be understood to connect two segments at layer 2 (security layer) of the OSI model in a computer network. A bridge within the meaning of this disclosure may optionally be arranged to operate on the MAC sublayer or the LLC sublayer. A bridge within the meaning of this disclosure may be a MAC bridge. A bridge within the meaning of this disclosure may be an LLC bridge. A bridge within the meaning of this disclosure may be a transparent bridge. A bridge within the meaning of this disclosure may be a source routing bridge. A bridge within the meaning of this disclosure may be a coupling element in computer networks. A bridge within the meaning of this disclosure may be a switch which, within a segment (broadcast domain), ensures that the data packets, known as ‘frames’, reach their destination. A bridge within the meaning of this disclosure may be a switch that generally refers to a multiport bridge (or an active network device) that performs forwarding based on information from the data link layer (layer 2) of the OSI model. A bridge within the meaning of this disclosure may be a bridging hub. A bridge within the meaning of this disclosure may be a switching hub. A bridge within the meaning of this disclosure may be a fibre optic LAN converter that can be used in the same way as a Switch, and a fibre optic connection can be connected externally or a fibre optic connection internally (converter to cache) via optical bridging.

In an advantageous embodiment of the invention, the controller comprises a first switch for interrupting the power supply to the first bridge by opening the first switch. A first switch within the meaning of this disclosure is, in particular, a MOSFET. A first switch within the meaning of this disclosure is, in particular, a switch that is open in the de-energised state. A first switch within the meaning of this disclosure can also be a control board that has a function comparable to a MOSFET but has implemented additional control instances such as an IC.

The controller can comprise a bridge controller, also known as a bridge appliance (e.g. Raspberry, microcontroller, etc.). This bridge controller controls the MOSFETs via their GPIOs and supplies them with voltage at the GATE. If there is voltage at the GATE, the source voltage (e.g. 5V) is switched and activates the bridge or switch. Switching the bridge or switch creates a physical connection between all lines connected to the bridge/switch. The intermediate storage/cache can be a storage device that accepts data and forwards it, provided that the appropriate bridge is switched.

In a further advantageous embodiment of the invention, the controller comprises a second switch for interrupting the power supply to the second bridge by opening the second switch.

A second switch within the meaning of this disclosure is, in particular, a MOSFET. A second switch within the meaning of this disclosure is, in particular, a switch that is open in the de-energised state. A second switch within the meaning of this disclosure can also be a control board that comprises a function comparable to that of a MOSFET, but has implemented additional control instances such as an IC.

Interrupting a power supply within the meaning of this disclosure is, in particular, a physical interruption.

In a further advantageous embodiment of the invention, the bridge controller is provided for generating a first switch signal for closing the first switch and for generating a second switch signal for closing the second switch, wherein the controller comprises the bridge controller. In a further advantageous embodiment of the invention, it is provided that the data backup system comprises a logic circuit with a first input for the first switch signal and a second input for the second switch signal, wherein the logic circuit comprises a first output and a second output and is arranged in such a way that the first switch signal is output at the first output unless the second switch signal is output at the second output, and that the second switch signal is output at the second output when the second switch signal is applied to the second input and the first switch signal is not output at the first output.

The second data transmission connection and/or the third data transmission connection and/or the fourth data transmission connection within the meaning of this disclosure are non-wireless data transmission connections. Non-wireless data transmission connections within the meaning of this disclosure are, in particular, data transmission connections in which the ‘data-carrying’ signals are transmitted in a solid material.

In a further advantageous embodiment of the invention, the first data transmission connection is arranged as an optical waveguide or comprises an optical waveguide.

In a further advantageous embodiment of the invention, it is provided that the second data transmission connection is arranged as an optical waveguide or comprises an optical waveguide. In a further advantageous embodiment of the invention, it is provided that the third data transmission connection and/or the fourth data transmission connection is arranged as an optical waveguide or comprises an optical waveguide.

Optical waveguides (OWG) within the meaning of this disclosure are, for example, optical fibre cables (OFC). Optical waveguides (OWG) within the meaning of this disclosure are, for example, cables and lines consisting of optical waveguides and partially assembled with plug connectors for transmitting light. The light is guided, for example, in fibres made of quartz glass or plastic (polymer optical fibre). They are often referred to as fibre optic cables, wherein several optical fibres are typically bundled together and are or can be mechanically reinforced to protect and stabilise the individual fibres. A single mode or a multimode can be provided.

From a physical point of view, optical fibres within the meaning of this disclosure are, for example, dielectric waveguides. They are constructed, for example, from concentric layers, wherein the light-conducting core is located, for example, in the centre, which is surrounded, for example, by a cladding with a slightly lower refractive index and, for example, by further protective layers of plastic. Depending on the application, the core has, for example, a diameter of a few micrometres to over a millimetre. Optical fibres are differentiated, for example, according to the refractive index gradient between the core and the cladding (step-index or gradient-index fibres) and the number of propagating modes, which is limited by the core diameter.

The aforementioned object is also solved by a network system, wherein the network system comprises a data backup system, for example a data backup system with one or more of the aforementioned features, and wherein the network system comprises a data network and the first data transmission connection between the data network and the first bridge by means of the data backup system interface.

The aforementioned object is also solved by a method for operating a network system with a backup storage, in particular by a method for operating a network system with the aforementioned features, wherein the network system comprises a first bridge (including a lock), an intermediate storage and a second bridge, wherein the network system comprises a first data transmission connection for data communication connecting a data network and the first bridge, wherein the first bridge and the intermediate storage are connected by means of a second data transmission connection of the network system for data communication, wherein the intermediate storage and the second bridge are connected by a third data transmission connection of the network system for data communication, and wherein the second bridge and the backup storage are connected by a fourth data transmission connection of the network system for data communication, wherein it is provided in particular that data of the data network to be backed up are transferred from the data network to the intermediate storage.

In an advantageous embodiment of the invention, it is provided that data to be backed up (from the data network) is stored in encrypted form on the backup storage. In a further advantageous embodiment of the invention, it is provided that data to be backed up is encrypted in the intermediate storage, transferred in encrypted form from the intermediate storage to the backup storage and stored in encrypted form on the backup storage.

In a further advantageous embodiment of the invention, the power supply to the second bridge is interrupted, wherein subsequently data to be backed up is transferred from the data network to the intermediate storage, wherein subsequently the power supply to the first bridge is interrupted, wherein subsequently the interruption of the power supply to the second bridge is cancelled, wherein subsequently the data to be backed up is transferred from the intermediate storage to the backup storage and stored in the backup storage. In a further advantageous embodiment of the invention, the power supply to the second bridge is then interrupted.

In order to restore data backed up by means of the backup storage, an advantageous embodiment of the invention provides for the interruption of the power supply to the second bridge to be lifted. In a further advantageous embodiment of the invention, the backed-up data is transferred from the backup storage to the intermediate storage and, if necessary, decrypted. In a further advantageous embodiment of the invention, the power supply to the second bridge is subsequently interrupted.

In an advantageous embodiment of the invention, the interruption of the power supply to the first bridge is lifted. In a further advantageous embodiment of the invention, the secured data is transferred from the intermediate storage to the data network. In a further advantageous embodiment of the invention, the power supply to the first bridge is then interrupted.

The two bridges in conjunction with the intermediate storage form a lock or implement a lock function. The power supply to the first bridge is interrupted when the interruption of the power supply to the second bridge is cancelled, and the power supply to the second bridge is interrupted when the interruption of the power supply to the first bridge is canceled. This ensures that both bridges cannot be switched at any point in time.

A circuit board can also prevent both locks, i.e. both bridges, from opening simultaneously in the event of hardware defects.

The bridge controller (bridge appliance that controls suitable bridges with its GPIOs) is advantageously not connected to the intermediate storage/cache or any other module by a connector. Instead, it is advantageously provided that the bridge controller runs independently, in particular to completely prevent unwanted external access. It is advantageously provided that switching times, etc. can only be set and edited by direct access to the bridge controller.

The measures listed ensure that at any point in time both bridges cannot be switched. A distinction is made between a first lock phase and a second lock phase. A phase referred to as the first lock phase concerns the case in which data from the data network (hereinafter also referred to as LAN) is to be fed to the intermediate storage (hereinafter also referred to as cache). In this case, the bridge controller (bridge appliance (manager)) switches on the first bridge in such a way that the first bridge is supplied with power. From this point in time, the LAN is ‘connected’ to the cache. This allows data to be transferred to the cache. This can continue until the bridge controller or bridge appliance switches off the first bridge again, i.e. the first bridge is disconnected from the power supply. From this point in time, the data in the cache is analysed. This means that it is analysed for malware and finally encrypted (symmetric encryption method).

In a second lock phase, the data can be transferred from the cache to the backup storage using a standardised and supported protocol of the backup storage/backup server (e.g. FTP/SMB/NFS). Again, this only takes place within the framework specified by the bridge controller/bridge appliance. All data or content transferred to the backup storage/backup server is encrypted without exception. This means that no malicious code can cause damage to the main memory without knowledge of the key (for encryption), as encrypted malicious code cannot be executed.

The configuration options for bridge control/bridge appliance are deliberately very limited. For ease of use and to minimise the risk of security incidents, it is only possible to set schedules for switching. The duration and/or number of time intervals is also advantageously limited so as not to jeopardise the security of the system without good reason. It is also possible to invert the switching process to restore the data. This also means that the number of transmitting end devices is limited. Certain processes in the cache also require computing capacity, which is time-dependent and also limits the number of end devices.

In addition to normal operation for the back-up function, the bridge appliance can also be set to restore mode. In this mode, data is periodically reloaded into the intermediate storage and transported from there to the corresponding terminal device in the LAN. The lock principle is completely inverted here. Only the intermediate storage is responsible for loading/encrypting and decrypting/analysing data.

Further advantages and details are apparent from the following description of embodiments. These show:

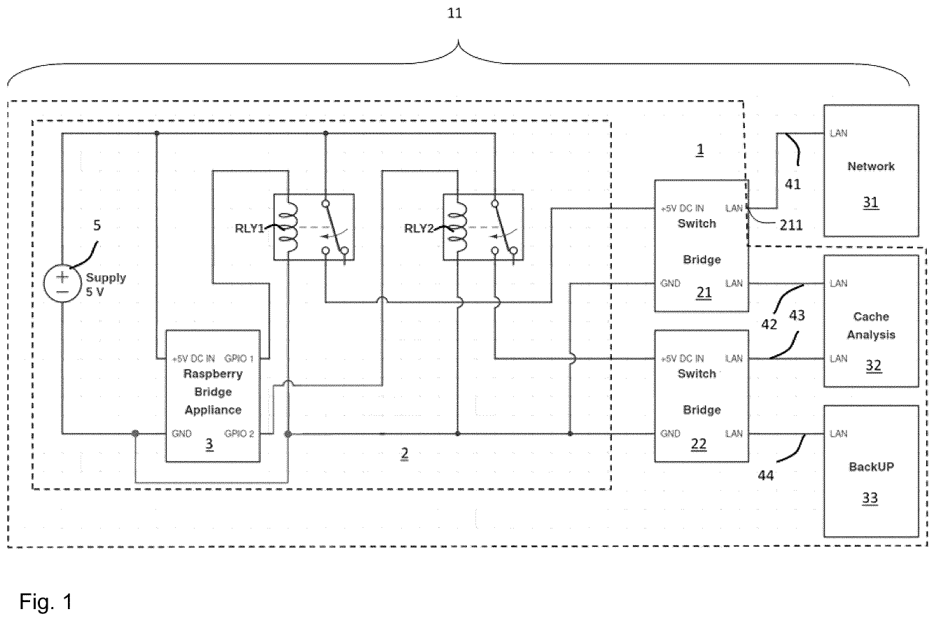

FIG. 1 an embodiment of a network system,

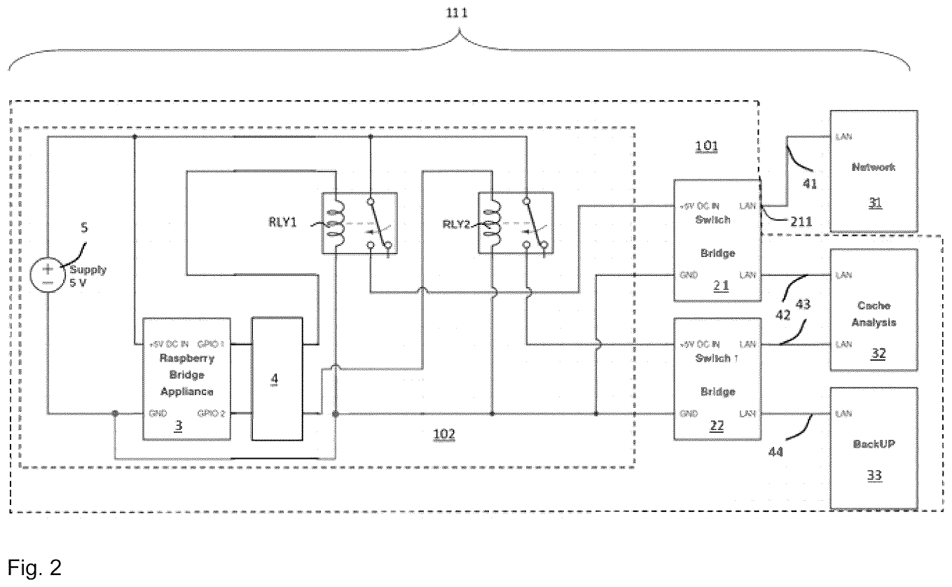

FIG. 2 an embodiment of an alternative network system,

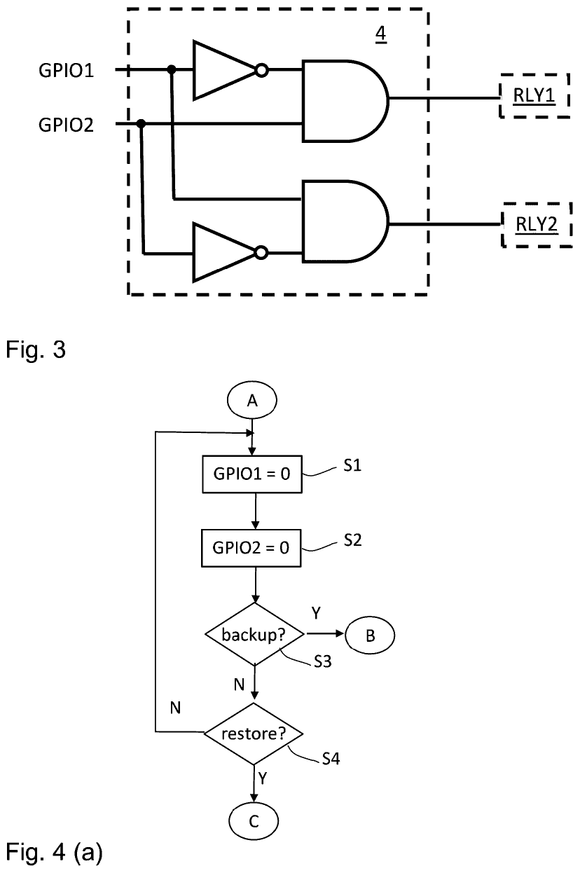

FIG. 3 an embodiment of a logic circuit,

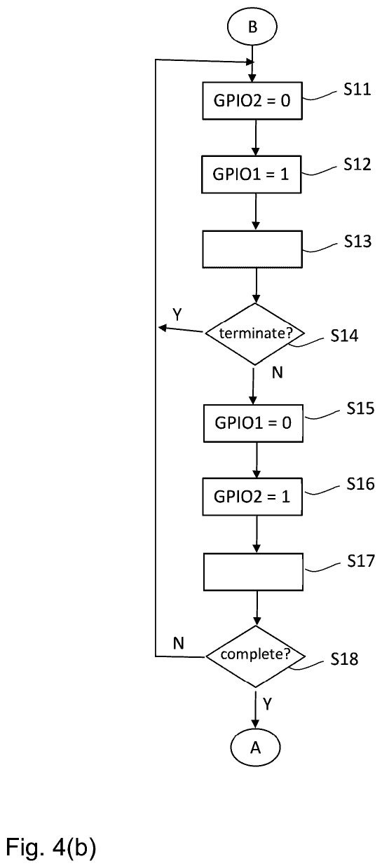

FIG. 4 an embodiment of a method for operating a network system according to FIG. 1, and

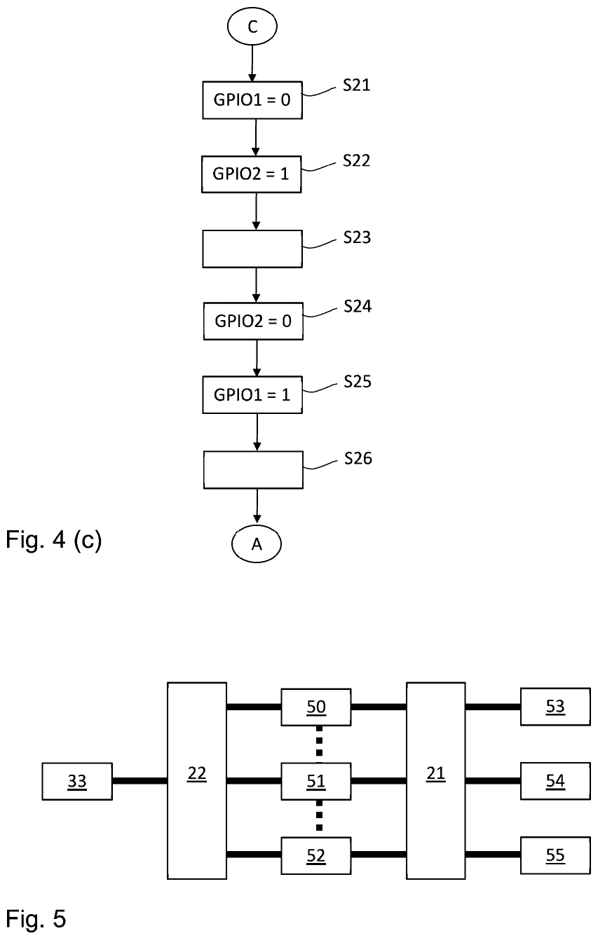

FIG. 5 an embodiment of a modified method for operating a network system.

FIG. 1 illustrates an example of a network system 11 with a data network 31 and a data backup system 1 for the data network 31, wherein the data backup system 1 comprises a backup storage 33 for storing data from the data network 31. The data backup system 1 also comprises a bridge 21, an intermediate storage 32 and a bridge 22. The network system 11 comprises a first, in particular non-wireless, data transmission connection 41 for connecting the data network 31 to the bridge 21 for data communication, wherein the bridge 21 comprises a data backup system interface 211 for implementing the data transmission connection 41.

The bridge 21 and the intermediate storage (32) are connected for data communication by means of a second, in particular non-wireless, data transmission connection 42. The second data transmission connection 42 can be arranged as an optical waveguide or comprise an optical waveguide. The intermediate storage 32 and the bridge 22 are connected for data communication by means of a third, in particular non-wireless, data transmission connection 43. The third data transmission connection 43 can be arranged as an optical waveguide or comprise an optical waveguide. The bridge 22 and the backup storage 33 are connected for data communication by means of a fourth, in particular non-wireless, data transmission connection 44. The fourth data transmission connection 44 can be arranged as an optical waveguide or comprise an optical waveguide.

No special technical requirements are necessary for the data network (e.g. LAN network) or backup storage. The operating system of end devices in the data network 31 or LAN and of the backup storage 33 supports, for example, only the (network) sockets defined in RFCs.

The power supply for bridge 21 and the power supply for bridge 22 are provided by a power source 5.

The data backup system 1 comprises a controller 2 configured in such a way as to interrupt the power supply to bridge 21 and to interrupt the power supply to bridge 22, so that at least the power supply to bridge 21 or the power supply to bridge 22 is interrupted. For this purpose, the controller 2 comprises a switch RLY1 arranged as a MOSFET for interrupting the power supply to bridge 21 by opening switch RLY1, so that the line between bridge 21 and voltage source 5 is interrupted, and a switch RLY2 arranged as a MOSFET for interrupting the power supply to bridge 22 by opening switch RLY2, so that the line between bridge 22 and voltage source 5 is interrupted. A bridge controller 3 or bridge appliance (e.g. Raspberry, microcontroller, etc.) controls the switches RLY1 and RLY2, which are designed as MOSFETs, via the GPIOs of the bridge controller 3 and supplies them with voltage at the GATE, referred to here as a switch signal. If voltage is applied to the GATE of the respective MOSFET, this means that the bridge assigned to this MOSFET is supplied with voltage.

FIG. 2 illustrates an example of an alternative network system 101 with an alternatively arranged controller 102, wherein the network system 101, in contrast to the network system 1 according to FIG. 1, comprises a logic circuit 4 illustrated in FIG. 3 as an example.

FIG. 4 describes an example of a method for operating the network system 11 or 111. A distinction is made between the idle phase described in FIG. 4 (a), the back-up phase described in FIG. 4 (b) with a first lock phase and a second lock phase, and the data restoration phase (restore) described in FIG. 4 (c) with the second lock phase and the first lock phase.

In the idle phase according to FIG. 4 (a), it is ensured that GPIO1 and GPIO2 do not output any switch signals, i.e. in step S1, GPIO1 is set to logical zero (GPIO1=0) and in step S2, GPIO2 is set to logical zero (GPIO2=0). In this case, both switches RLY1 and RLY2 are open and the power supply (via voltage source 5) is interrupted for bridge 21 and bridge 22. Power supply is used here as a synonym for current supply and voltage source as a synonym for current source. If data backup is desired (compare query in step S3 or ‘backup?’), the backup phase is started with the first lock phase as described in FIG. 4 (b). In step S11, GPIO2 is set to logical zero (GPIO2=0) and in step S12, GPIO1 is set to logical 1 (GPIO1=1). Then, in step S13, the data from data network 31 to be backed up is transferred via bridge 21 to the intermediate storage/cache 32. The data to be backed up is transferred until a termination condition in step S14 (compare ‘terminate?’) is met. This termination condition may mean that all data to be backed up has been transferred to the intermediate storage (32). However, it may also mean that a certain time has been exceeded or a certain amount of data has been reached.

If the termination condition in step S14 is met, the power supply to the bridge 21 is interrupted by setting GPIO1 logically to zero (GPIO1=0) in step S15. This interrupts the power supply to the bridge 21 and switches off the bridge 21. Then, in step S16, bridge 22 is switched on or supplied with power by setting GPIO2 logically to 1 (GPIO2=1). Then, in step S17, the data stored in the intermediate storage (32) is analysed for malware and encrypted, and the encrypted data is transferred from the intermediate storage (32) to the backup storage 33 via the bridge 22. Alternatively, the encryption and malware check can be performed before step S16, so that in step S17 only the encrypted data is transferred from the intermediate storage 32 to the backup storage 33 via the bridge 22. If the query in step S18 reveals that not all of the data to be backed up from the data network 31 has been transferred (compare query in step S18 ‘complete?’), the steps starting with step S11 are carried out again. Otherwise, the network system 11, 111 returns to the idle phase according to FIG. 4 (a).

If backed-up data stored in encrypted form in the backup storage 33 is to be restored in the data network 31, the network system 11 or 111 enters the data restoration phase (restore) beginning with the second lock phase according to FIG. 4 (c). To do this, step S21 first ensures that the power supply to the bridge 21 is interrupted by setting GPIO1 to logical zero (GPIO1=0). Then, in step S22, the bridge 22 is supplied with power by setting GPIO2 to logical 1 (GPIO2=1). In step S23, the encrypted backed-up data is transferred from the backup storage 33 to the intermediate storage 32, and the data transferred to the intermediate storage 32 is decrypted. Then, in step S24, GPIO2 is set to logical zero (GPIO2=0), i.e. the power supply to bridge 22 is interrupted. Then, in step S25, GPIO1 is set to logical 1 (GPIO1=1), i.e. the interruption of the power supply to bridge 21 is cancelled. This is followed by step S26, in which the data to be restored is transferred from the intermediate storage 32 to the data network 31 via bridge 21. The transfer can take place in a single transfer process as described, or alternatively in batches, i.e. divided into several transfer processes.

Both steps S11 and S12 and steps S24 and S25 form a first lock phase. Both steps S15 and S16 and steps S21 and S22 form a second lock phase.

The disclosed procedure provides a high level of security for the backup data (i.e. the data in the backup storage 33). In order to protect the backup data even better against destruction, the following attack possibility must be addressed:
Wait for Bridge 21 to switch.
Exploit the Linux system (cache) with an unknown ‘super exploit’ and place malicious code past the encryption.
Wait for Bridge 22 to switch.
Gaining access to data in the backup storage and deleting/overwriting files.

This attack scenario describes only a theoretical model and is currently hardly possible in practice. In relation to the effort required for attacks on current systems, this attack scenario represents a significantly increased effort for the attacker, as the attacker must overcome the first lock phase and the second lock phase. Thus, the risk of an attack on the main memory/backup memory is not impossible, but it is very unlikely, as in most cases it is not proportional to the time, computing and financial resources required.

The main unit HSS (Main SafeStorage), which is part of the intermediate storage, achieves the basic objectives of protection against ransomware. However, this also presents various challeng-es that can push the HSS (Main SafeStorage) to its processing limits:
The amount of data in the initialisation phase exceeds an acceptable processing time.
The processing volume in systems exceeds the capacity of the data in a 24-hour cycle (or even shorter cycles).
The use of parallel HSS is not efficient, as such a configuration requires different HSS, although technically only one valid configuration is needed. With smart restoring, there may be problems with the provision of netboot images, as more than one PXE server within a network would need to be specified via DHCP.

The performance of the system is a limiting factor in each of the points mentioned. This applies in particular to the evaluation by anti-malware software integrated into SafeStorage. In addition, unique assignment should be possible in the case of smart restoring. Therefore, it is advantageous to provide only one main SafeStorage (HSS), which acts as the central management point for client configurations, stores the network infrastructure and thus also implements smart restoring (data recovery). Since the process of the lock is reversed in the case of smart restoring, there is no loss of speed. Malware analyses are not necessary when reversing the process and providing the netboot images.

In an advantageous further design of the system, additional performance is ensured through the use of LMUs (performance module supports). The principle becomes apparent in FIG. 5, wherein reference numbers 53, 54, 55 denote client networks, such as data network 32. The HSS 50 in conjunction with the LMUs 51 and 52 replaces the described intermediate storage 32 (also referred to as cache or cache memory), wherein the authentication methods with the LMUs 51 and 52 are enabled using the same method as that with the main system or main SafeStorage (HSS) designated by reference number 50. The lock procedure, including the bridge appliance controller, i.e. the bridge control, is also integrated. This enables a complete lock procedure. An equivalent analysis of malware with equivalent software components takes place on the LMUs.

The differences between the HSS and the LMUs may result from their respective responsibilities. For example, smart restoring, i.e. the restoration of data, only takes place at the HSS, wherein it may be envisaged that LMUs are not involved in the process. It may be envisaged that the client database used for authentication is performed in synchronisation loops. This is done, for example, through the internal communication circuit, provided that the HSS and an LMU are physically connected in a network. (In FIG. 5: connected by bridge 22/switch on the left-hand side).

It may be stipulated that an LMU requires the following configuration information:
(Fixed) IPv4 address and/or domain
Bridge appliance switching times of the lock system
Login data of an LMU at the HSS for synchronising the client authorisation data

The LMU has a height of 1U and does not have a screen. The settings are transmitted via a web panel (bridge control/bridge appliance and intermediate storage/cache separately). During the initial configuration, the client notes which LMU (domain/IPv4) it should use for initial synchronisation and whether this LMU is integrated into the network on a long-term basis or only serves for initial data processing. In addition, the IPv4/domain of the HSS is noted for restoring (applies to restoring stages that do not correspond to PXE boot).

In order to ensure larger data transfer rates during the initialisation phase, as all data from the entire network should be transferred to the backup storage at the beginning, LMUs are issued to the customer as standard. The number of initialisation LMUs used depends on the amount of data to be processed. Once the initial processing is complete, the LMUs are removed and used for initialisation at the next customer's site. Alternatively, SafeStorage can make the LMUs available to the network on a long-term basis using the familiar business models (leasing/purchase/indirect sales). This can also be done retrospectively.

A new scaling for the need for additional LMUs can be justified in particular by
the use of more clients,
a shorter backup cycle,
or an increasing data stream.

### LIST OF REFERENCE NUMBERS

1, 101 Data backup system
2, 102 Controller
3 Bridge controller
4 Logic circuit
5 Power supply
11, 111 Network system
RLY1 Switch/MOSFET
RLY2 Switch/MOSFET
21 Bridge/switch
22 Bridge/switch
31 Data network
32 Intermediate storage/cache
33 Backup storage
41 First (e.g. non-wireless) data transmission connection (between the first bridge and the data network)
42 Second (non-wireless) data transmission connection (between the first bridge and the intermediate storage)
43 Third (non-wireless) data transmission connection (between the intermediate storage and the second bridge)
44 Fourth (non-wireless) data transmission connection (between the second bridge and the backup storage)
50 HSS
51 LMU1/power module support
52 LMU2/power module support
53 Client system 1
54 Client system 2
55 Client system 3
211 Data backup system interface
S1, S2, S11,
S12, S13, S15,
S16, S17, S21,
S22, S23, S24,
S25, S26 Step
S3, S4, S14, S18 Query

1. A data backup system (1, 101) for data to be backed up from a data network (31), wherein the data backup system (1, 101) comprises a backup storage (33), wherein the data backup system (1, 101) further comprising a first bridge (21), an intermediate storage (32) and a second bridge (22), wherein the data backup system (1, 101) and/or the first bridge (21) comprise a data backup system interface (221) for a first data transmission connection (41) for connecting the data network (31) and the first bridge (21) for data communication, wherein the first bridge (21) and the intermediate storage (32) are connected for data communication by means of a second data transmission connection (42), wherein the intermediate storage (32) and the second bridge (22) are connected for data communication by means of a third data communication connection (43), wherein the second bridge (22) and the backup storage (33) are connected for data communication by means of a fourth data communication connection (44), wherein the data backup system (1, 101) comprises a controller (2, 102) configured to interrupt a power supply to the first bridge (21) and to interrupt the power supply to the second bridge (22) in such a way that at least the power supply to the first bridge (21) or the power supply to the second bridge (22) is interrupted.

2. The data backup system (1, 101) according to claim 1, wherein the controller (2, 102) comprises a first switch (RLY 1) for interrupting the power supply to the first bridge (21) by opening the first switch (RLY1).

3. The data backup system (1, 101) according to claim 1, wherein the controller (2, 102) comprises a second switch (RLY2) for interrupting the power supply to the second bridge (22) by opening the second switch (RLY2).

4. The data backup system (1, 101) according to claim 3, wherein the controller (2, 102) comprises a bridge controller (3) for generating a first switch signal for closing the first switch (RLY1) and for generating a second switch signal for closing the second switch (RLY2).

5. The data backup system (101) according to claim 4, wherein the data backup system (101) and/or the controller (102) comprises a logic circuit (4) with a first input for the first switch signal and a second input for the second switch signal, wherein the logic circuit (4) comprises a first output and a second output and is arranged such that
that the first switch signal is output at the first output, but only if the first switch signal is applied to the first input and the second switch signal is not output at the second output, and/or
the second switch signal is output at the second output, but only if the second switch signal is applied to the second input and the first switch signal is not output at the first output.

6. The data backup system (1, 101) according to claim 1, wherein the second data transmission connection (42) is arranged as an optical waveguide or comprises an optical waveguide.

7. The data backup system (1, 101) according to claim 1, wherein the third data transmission connection (43) and/or the fourth data transmission connection (44) is arranged as an optical waveguide or comprises an optical waveguide.

8. A network system (11, 111), wherein it comprises a data backup system (1, 101) according to claim 1, a data network (31) and the first data transmission connection (41) between the data network (31) and the first bridge (21) by means of the data backup system interface (211).

9. A method for operating a network system (11, 111) with a backup storage (33), in particular a method for operating a network system (11, 111) according to claim 8, wherein the network system (11, 111) comprises a first bridge (21), an intermediate storage (32) and a second bridge (22), wherein the network system (11, 111) comprises a first data transmission connection (41) for connecting a data network (31) and the first bridge (21) for data communication, wherein the first bridge (21) and the intermediate storage (32) are connected for data communication by means of a second data transmission connection (42) of the network system (11, 111), wherein the intermediate storage (32) and the second bridge (22) are connected for data communication by means of a third data transmission connection (43) of the network system (11, 111), and wherein the second bridge (22) and the backup storage (33) are connected for data communication by means of a fourth data transmission connection (44) of the network system (11, 111).

10. The method according to claim 9, wherein data from the data network (31) to be backed up is stored in encrypted form in the backup storage (33).

11. The method according to claim 9, wherein data from the data network (31) to be backed up is encrypted in the intermediate storage (32), transferred in encrypted form from the intermediate storage (32) to the backup storage (33) and stored in encrypted form in the backup storage (33).

12. The method according to claim 9, wherein the power supply to the second bridge (22) is interrupted, wherein subsequently data to be backed up of the data network (31) is transferred from the data network to the intermediate storage (32), wherein subsequently the power supply to the first bridge (21) is interrupted, wherein subsequently the interruption of the power supply to the second bridge (22) is cancelled, wherein subsequently the data of the data network (31) to be backed up is transferred from the intermediate storage (32) to the backup storage (33) and stored in the backup storage (33).

13. The method according to claim 12, wherein subsequently the power supply to the second bridge (22) is interrupted.
